(19) United States
(12) Patent Application Publication
(10) Pub. No.: US 2026/0346953 A1
(43) Pub. Date: Nov. 5, 2026

(54) Window Assembly

(71) Applicant: C.C. JENSEN A/S, Svendborg (DK)

(72) Inventor: Henning BUCH, Syendhorg (DK)

(73) Assignee: C.C. JENSEN A/S, Svendborg (DK)

(21) Appl. No.: 19/484,932

(22) PCT Filed: May 16, 2024
(86) PCT No.: PCT/EP2024/063507

§ 371 Date: Nov. 17, 2025

(30) Foreign Application Priority Data
May 17, 2023 (EP) 23173935.0

(51) Int. Cl. B63B 19/00

(52) U.S. Cl. CPC B63B 19/00; B63B 2019/0007

(57) ABSTRACT

The invention provides a window assembly which fulfil the requirements for windows for offshore constructions in respect or fire resistance and resistance to pressure due to wind and water impact. According to the invention the F-profile which is normally used as basis for the window frame to encapsulate the window glass has been replaced with individual spacers welded to a L-shaped standard steel profile window frame, leading to material and labor savings whereby manufacturing costs and lead time are reduced.

### TECHNICAL FIELD

The present invention relates to a window assembly for being mounted in an aperture/opening in an offshore construction and a method for manufacturing the window assembly.

### BACKGROUND

Window assemblies such as windows and portholes built into the structure of offshore constructions are commonly made up by a window frame and a window box, see e.g. document U.S. Pat. No. 2,826,282. The window frame accommodates the glass, the glass list, and gasket system and is mounted directly in pre-defined carvings/cut-outs, i.e. apertures/openings, in the outer hull structure during the early construction process. So far, within the technical field of window assemblies, the window box is the inner part that makes up the air-, gas-and sound-tight connection/membrane between the inner bulk-head liner, i.e. the inner part of the hull structure, and the window frame. The window frame may be made of aluminium or steel.

Also, the document CN 115092322 describes a window frame for offshore constructions. The window frame comprises several reinforcement frames which are cut in desired sizes and connected by welding to form a continuous mounting frame. The use of several individual reinforcement frames welded together improves the strength of the mounting frame and the window, in particular when the window opening is large. However, the welding is also work intensive.

During the construction and building of large vessels, platforms and other offshore constructions, the window frames are typically installed at an early stage of the construction process. Only much later in the construction process, the inner (bulkhead) lining/panel, such as in accommodation and operation spaces, is established, so that the window box can be mounted.

Normally, the window frame that accommodates the glass, the glass list and the gasket system, consists of a customized F-profile which is cut in desired length, bent and shaped, and the two free ends welded together to form a continuous frame that fits into the window aperture/opening in the outer hull structure.

The F-profile is typically made of steel and manufactured using hot extrusion technology. The drawback using such F-profile is that each profile must be individually customized to match the thickness of the window glass with gaskets, thereby limiting the possibility of stocking the material, and may cause long lead time, and increase the costs. Also, each individual F-profile requires appropriate and sometimes individually customized manufacturing tools for the hot extrusion process.

Another drawback is that the process of drilling matching holes in the glass list material and the frame material is slow and complicated. The glass list and the frame material are normally manufactured in different materials such as stainless steel and black steel. This complicates the manufacture of the window, e.g. in the drilling process. When holes are drilled for mounting the window glass, the glass list is placed on the frame and holes are drilled in the glass list and frame in the same drilling operation to obtain matching holes. Due to the different materials the operation may challenge the drilling tools and make the drilling operation last significantly longer.

Within the present invention, the term offshore constructions is to be understood as sea-going vessels of all kinds (ships) and jack-up, fixed, floating and semi-submerged oil rigs (oil platforms/offshore platforms) and other floating objects or installations fixed on the sea bed for oil and gas production and storage as well as accommodation installations, such as hotels or sleeping quarters.

### Disclosure of the Invention

The aspect of the invention is to provide a manufacturing process of windows for offshore constructions which is simpler and more cost-effective than in known offshore constructions and also providing basis for shorter lead time from order to delivery

The invention provides a solution where standard L-shaped structural steel, e.g. according to EN 10056, forms the basis for the construction of the window frame, thus eliminating the need for individually customized F-profile steel, thereby reducing the lead time but also the number of different prefabricated material profiles and related costs significantly. The invention also provides a solution which is labour, time, and material saving and makes the manufacturing of windows for offshore constructions simpler and more flexible by the use of spacers individually attached to a standard L-profile steel. For example, the drilling process is simplified compared to the known windows because you only need to drill in a single material. The spacers with desired dimensions and tapped (threaded) hole are easy and fast to manufacture also in large numbers.

In a first aspect, the present invention relates to a window assembly for being mounted in an aperture/opening in an offshore construction, the window assembly comprising
a window frame having an outer portion and an inner portion, said outer portion being adapted to be attached to an outer part of said offshore construction, said inner portion being adapted for engagement with a shielding unit,
a window glass having a first side and a second side and being adapted for closing said aperture/opening and having a first periphery along the first side being adapted for covering and contacting at least a part of said inner portion,
a glass list being adapted for covering and contacting a second periphery along the second side of the window glass and pressing said first periphery of the window glass against said inner portion, said window glass and the glass list forming the shielding unit, and wherein said glass list is connected to the inner portion by spacers individually attached to the inner portion and providing a distance between the inner portion and the glass list.

Normally, the window assembly is mounted in the aperture/opening of the offshore construction by means of welding, rivets, screws, nails or gluing. The connection between the aperture/opening and the window assembly should be watertight, and tightening means, such as e.g. gaskets or sealing fluids, may be applied.

In relation to the window frame, the distance provided by the spacers generally corresponds to the thickness of the window and optional gaskets. Thus, the window is attached to the window frame by means of the spacers and the glass list. Normally, the window frame will have an L-shaped cross section, and the spacers will be attached to one side of the window frame, i.e. the inner portion, as illustrated in the figures.

Normally, the window assembly includes one or more gaskets serving to tighten the window opening and also reducing pressure directly on the window glass from the window frame and the glass list. Consequently, in an embodiment of the window assembly, the shielding unit further comprises a first gasket along the first periphery and/or a second gasket along the second periphery, preferably said first gasket being located between the first periphery and the inner portion, and preferably said second gasket being located between the second periphery and the glass list. In this manner, the forces acting between contact points of the window glass to the inner portion and to the glass list may be reduced, thereby sealing the opening and reducing the risk of harmful occurrences such as cracks in the window glass. Although the gaskets run along the periphery on both side of the window glass, the gaskets are not necessarily identical, but in some embodiments they are identical. The gaskets may e.g. be made from rubber such as silicone rubber.

The spacers, which serve to attach the glass list and thereby the window glass to the window frame, are substantially identical and having a length between a first and second end, said length being between 5 mm to 100 mm, preferably between 10 mm to 50 mm. Preferably, the spacers are made from a metallic alloy such as corrosion resistant alloys.

Although the spacers may have any desired shape, the spacers in an embodiment are substantially identical and having a cylindrical shape with a diameter from 8 mm to 40 mm, preferably from 10 mm to 30 mm. Spacers having such dimensions are very suitable for attaching the glass list to the window frame.

Moreover, the spacers are substantially identical and having a planar first end and a planar second end having a tapped (threaded) hole, preferably said first planar end is attached to the inner portion, and preferably said second planar end is attached to the glass list. This also facilitates the attachment of the glass list to the window frame.

Preferably, the spacers are attached to the inner portion of the window frame by welding, typically bolt-or stud welding Alternatively the spacers may be attached by gluing, by use of screws, or by use of rivets or nails.

Although the spacers may be attached to the glass list by the above-mentioned means, in an embodiment the spacers are attached to the glass list by bolts, screws, rivets or nails, and in particular screws that fit into the tapped (threaded) hole of the second end of the spacer. The use of such means facilitates the mounting of the glass list and the window glass to the window frame.

The spacers should ensure a proper attachment between the glass list and the window frame and in an embodiment of the window assembly, the spacers are attached to the inner portion and the glass list at intervals ranging from 20 mm to 150 mm, preferably ranging from 35 mm to 100 mm. The spacers are attached substantially in line following the shape of the glass list and the inner portion. By having the intervals between the individual spacers, a proper and durable attachment between the glass list and the window frame can be achieved.

The use of spacer makes the manufacturing process simpler and faster in relation to the traditional offshore windows with continuous frame welded to the window opening. Moreover, when using the spacers the formation of cold/heat bridges in the window structure has appeared to be significant reduced. Furthermore, under arctic conditions where condensation can form, it is easier to ventilate away the condensation.

In an embodiment of the window assembly, the window frame has an L-shaped cross section. The configuration with L-shaped cross section makes it possible in an uncomplicated manner to attach one section of the L-shape to the outer part of the offshore construction and having the other section attached to the glass list by means of the spacers.

In principle, the glass list may have any shape which follows the circumference of the window frame, and preferably in an embodiment of the window assembly the glass list is formed as a rim, preferably a square, rectangular or circular rim. Although the glass list may be made from plastic or synthetic materials, it is preferred that the glass list is made from steel such as stainless steel. The glass list and the window assembly may be provided with a coating, such as paint.

In an embodiment of the window assembly, the window assembly comprises a further window glass, preferably in the outer portion of the window frame. This may improve the functionality and strength of the window e.g. in respect of wind pressure or fire.

The window assembly according to the invention may be used for all off-shore constructions, such as off-shore constructions selected from a ship, a vessel, an oil and/or gas rig.

In an aspect, the invention relates to a method for manufacturing a window assembly for being mounted in an aperture/opening in an offshore construction, said method comprising
providing a window frame having an outer portion and an inner portion, where said outer portion is adapted to be attached to an outer part of said offshore construction, said inner portion being adapted for engagement with a shielding unit,
providing a window glass having a first side and a second side and being adapted for closing said aperture/opening and having a first periphery along the first side being adapted for covering and contacting at least a part of said inner portion,
providing a glass list being adapted for covering and contacting a second periphery along the second side of the window glass and pressing said first periphery of the window glass against said inner portion, said window glass and the glass list forming the shielding unit,
attaching spacers to the inner portion,
placing the window glass between the inner portion and the glass list, and
connecting said glass list to the inner portion by attaching the glass list to the spacers thereby providing a distance between the inner portion and the glass list, and thereby encapsulating the window glass between the inner portion and the glass list.

The method may be applied to a window frame before it is mounted in an offshore construction e.g. in a workshop, or the method may be applied to the window frame after the frame has been mounted in an offshore construction. In this manner, the method provides great freedom for the mounting of windows in an offshore construction.

The method may also include the step of providing gaskets between the inner portion and the window and between the glass list and the window glass to seal the aperture/opening efficiently.

According to an embodiment of the method, the spacers are attached to the inner portion by means of welding, typically bolt or stud welding.

The glass list may be attached to the spacers by means of e.g. rivets, nails, gluing or welding, but in an embodiment of the method the glass list is attached to the spacers by means of screws, e.g. buttonheads according to DIN 7380 having dimensions and threading that fit into the tapped (threaded) hole of the spacer. When holes are drilled in the glass list for the screws, this may be done in more glass lists at a time by placing the lists on top of each other, in this manner time may be saved.

The invention provides a window assembly which fulfils the requirements for windows for offshore constructions in respect or fire resistance and resistance to pressure due to wind and water impact. In case of fire-resistant windows, it has appeared that a significantly lower flux is directed through the construction to the unexposed side. According to the invention, the F-profile normally used as basis the for the window frame to encapsulate the window glass, has been replaced with a L-profile with individual spacers welded to the L-profile window frame, thus leading to significantly reduced lead time and to material and labor savings whereby manufacturing costs are reduced.

Preferably, the window frame and spacer are made from metallic alloys such as corrosion-resistant alloys, and the window glass fulfils the requirements of ISO 614, and the glass list fulfils the requirements of AISI 304.

### BRIEF DESCRIPTION OF THE DRAWING(S)

The invention is explained in detail below with reference to the drawing(s), in which

FIG. 1 illustrates an embodiment of the prior art;

FIG. 2 illustrates a 3D view of the embodiment of FIG. 1;

FIG. 3 illustrates an embodiment according to the present invention;

FIG. 4 illustrates a 3D view of the embodiment of FIG. 3;

FIG. 5 illustrates an embodiment according to the present invention;

FIG. 6 illustrates a 3D view of the embodiment of FIG. 5.

The figures are only intended to show the principles of the invention, and details, which do not form part of the invention, may be omitted. The same reference numbers are used for the same parts.

### DETAILED DESCRIPTION OF THE INVENTION

The invention provides window frames for offshore use which meet the requirements of fire resistance and pressure resistance in respect of offshore constructions which can be manufactured in a simpler and more cost-effective manner than the known types of window frames.

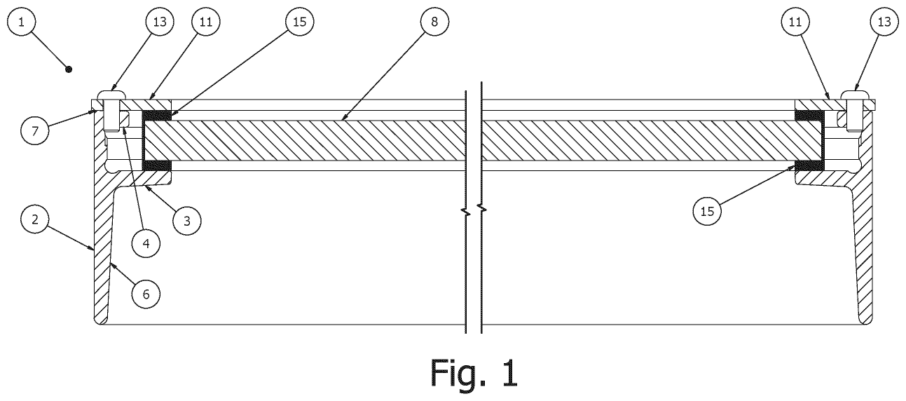

FIG. 1 shows a cross section of a window assembly 1 of the known type. The assembly has a window frame 2 which has a substantially F-shaped cross section and having an outer portion 6 and an inner portion 7. The F-shaped window frame 2 includes a flange 3 and a flange 4. The flange 4 is connected with a glass list 11 by means of a screw 13. During manufacturing, the inner portion 7 comprising the flange 4 is normally attached to the outer portion 6 together with the flange 3. The width of the window glass 8 and gaskets 15 determines the width of the inner portion 7, such that when a decision of window type and gasket has been made, the width and size of the inner portion can be determined, and the dimensions of the F-shaped window frame 2 can be determined. However, the manufacture process of the specific frame is time consuming and quite labour-intensive

The flange 4 and the glass list 11 together with the flange 3 encapsulate the window glass 8. Between the flange 3 and the window glass 8 and between the glass list 11 and the window glass 8 gaskets 15 are mounted.

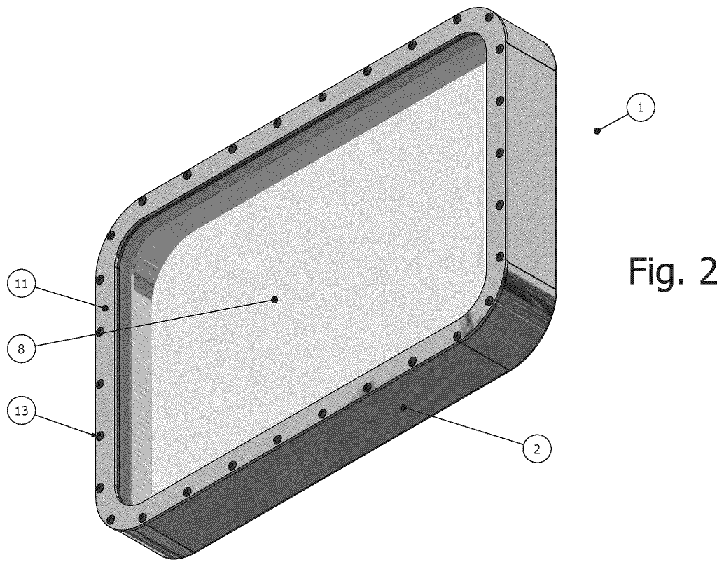

FIG. 2 shows the window assembly 1 of FIG. 1 in a 3D view with the window frame 2 having the glass list 11 attached by means of screws 13 to enclose the window glass 8.

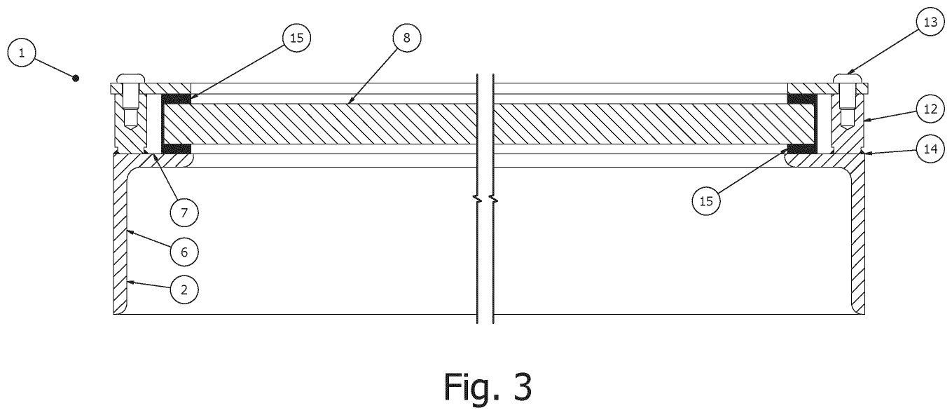

FIG. 3 shows a window assembly 1 according to the invention. In this embodiment, the window assembly comprises a window frame 2 with a substantially L-shaped cross section. The window frame 2 comprises an outer portion 6 and an inner portion 7. The outer portion 6 can be attached to the edges of a window opening (not shown).

At the inner part of the window frame 2, spacers 12 are attached with one end to the inner portion 7 by welding 14. At the opposite end, the spacer 12 is connected with a glass list 11 by means of screws 13 fastened in the tapped (threaded) hole.

The glass list 11 runs along the periphery of the window glass 8, but does not cover the window glass 8 (and gasket 15) entirely. A part of the glass list, an outer part, does not cover the window glass 8, but serves to connect the glass list 11 with the spacers 12.

The glass list 11 serves to encapsulate the window glass 8 via gasket 15 running along the periphery of the second side 10 of the window glass 8. Another gasket 15 is located between the first side 9 of the window glass 8 and the inner portion 7 of the window frame 2. The gaskets 15 on each side of the window glass 8 cooperate with the inner portion 7 and the glass list 11 to maintain the window glass 8 in position in the window frame 2 by means of pressure. The length of the spacers 12 also serves to determine the pressure on the window glass 8 and gaskets 15. Thus, the length of the spacers 12 can be determined, when the width of the window glass 8 and the gaskets 15 are determined.

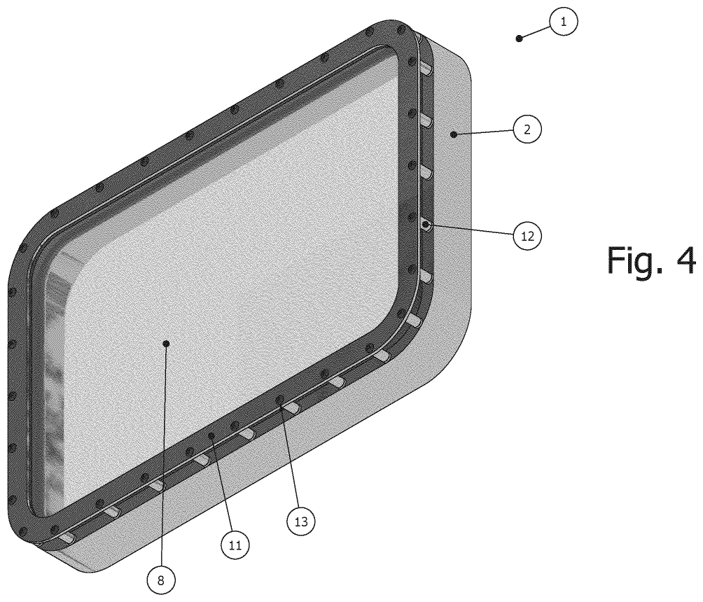

FIG. 4 shows a 3D illustration of the window assembly 1 of FIG. 3. The window frame 2 is connected with the glass list 11 via the spacers 12 attached to the window frame 2 by welding 14 and to the glass list by screws 13 fastened in the tapped (threaded) hole. Thereby, the window glass 8 is kept in place in the window assembly 1.

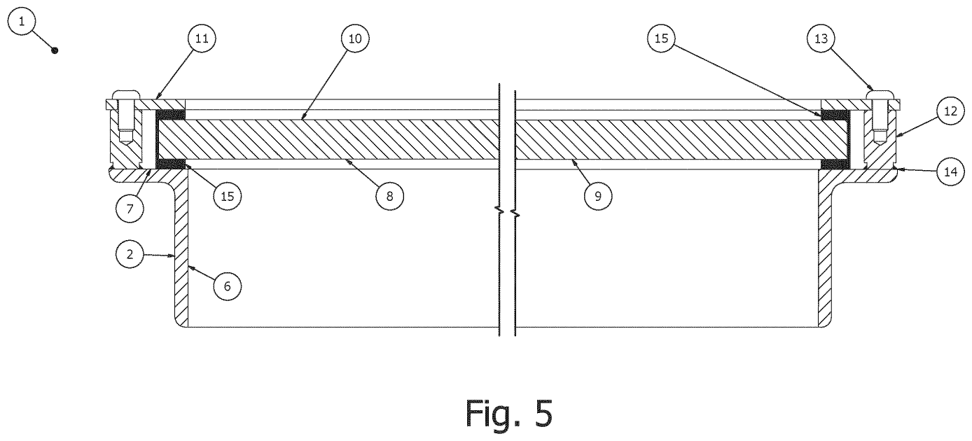

FIG. 5 shows an alternative embodiment of the window assembly 1 according to the invention. Similar to the embodiment shown in FIG. 3, the window assembly comprises a window frame 2 which has a substantially L-shaped cross section. However, in comparison with the window frame in FIG. 3, the L-shaped cross section of the window frame 2 is turned 180 degrees. The window frame 2 also includes an outer portion 6 and an inner portion 7, and due the 180 degrees turning of the L-shape the inner portion 7 forms a projecting flange around the window assembly 2

For mounting the window, glass spacers 12 are attached with one end to the inner portion 7 by welding 14. At the opposite end, the spacers 12 are connected with a glass list 11 by means of a screws 13.

The glass list 11 serves to secure the window glass 8 in the window assembly by means of the gaskets 15. One of the gaskets 15 is running along the periphery of the second side 10 of the window glass 8, and the other gasket runs on the opposite side of the window glass 8 along the periphery of the first side 9 of the window glass 8 and facing the inner portion 7 of the window frame 2. This means that a gasket 15 is located between the first side 9 of the window glass 8 and the inner portion 7 of the window frame 2, and another gasket is located between the second side 10 of the window glass 8 and the glass list 11. Thus, the gaskets 15 on each side of the window glass 8 cooperate with the inner portion 7 and the glass list 11 to maintain the window glass 8 in the correct position in the window frame 2 by means of pressure.

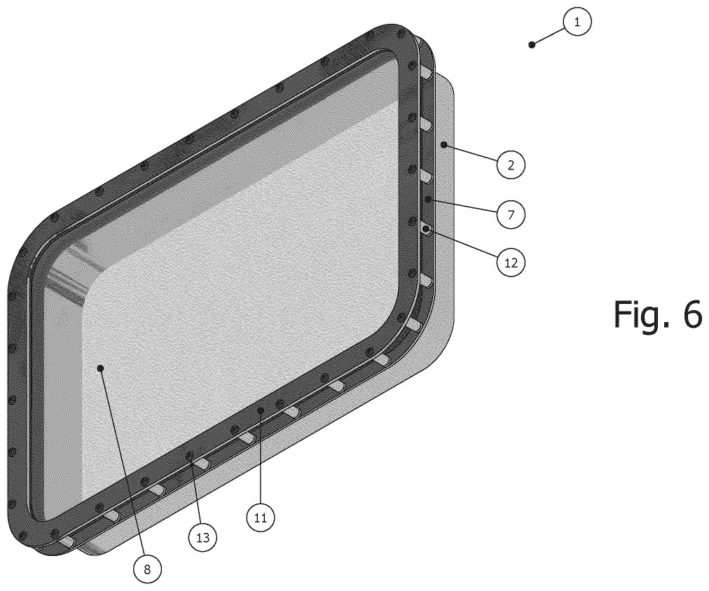

FIG. 6 shows a 3D illustration of the window assembly 1 of FIG. 5. The window frame 2 is connected with the glass list 11 via the spacers 12 attached to the window frame 2. The L-shape of the cross section of the window frame 2 connected with the glass list 11 forms a projecting flange around the window assembly, where the inner portion 7 of the window frame 2 and the glass list project. The spacers are attached to the inner portion by welding 14, and the glass list 11 is connected with the spacers by screws 13. Thereby, the window glass 1 is kept in place in the window assembly 1.

The embodiments presented above are manufactured for use in offshore constructions and are designed to withstand the conditions in an offshore environment, e.g. the corners are rounded like windows in aircrafts to avoid cracks due to fatigue. Measures are also taken in respect of fire and wind and water effects. Moreover, the materials used and the production methods should normally be in compliance with the relevant industrial standards (ISO, DIN, AISI).

The skilled person would also realise that the window assemblies according to the invention presented in FIGS. 4-6 can be designed in different ways, e.g. with two or three window glasses forming two or three layered windows.

### LIST OF REFERENCES

1 window assembly
2 window frame
3 flange
4 flange
6 outer portion
7 inner portion
8 window glass
9 first side
10 second side
11 glass list
12 spacer
13 screw
14 welding
15 gasket

1. A window assembly for being mounted in an aperture or opening in an offshore construction, the window assembly comprising
a window frame having an outer portion and an inner portion, said outer portion being adapted to be attached to an outer part of said offshore construction, said inner portion being adapted for engagement with a shielding unit,
a window glass having a first side and a second side and adapted for closing said aperture/opening and having a first periphery along the first side being adapted for covering at least a part of said inner portion, and
a glass list being adapted for covering a second periphery along the second side of the window glass and pressing said first periphery of the window glass against said inner portion, said window glass and the glass list forming the shielding unit, and
wherein said glass list is connected to the inner portion by spacers individually attached to the inner portion and providing a distance between the inner portion and the glass list, and
wherein the spacers are substantially identical and have a planar first end and a planar second end, said planar first end is attached to the inner portion, and said planar second end is attached to the glass list.

2. A window assembly according to claim 1, wherein the shielding unit further comprises a first gasket along the first periphery and/or a second gasket along the second periphery, preferably said first gasket being located between the first periphery and the inner portion, and preferably said second gasket being located between the second periphery and the glass list.

3. A window assembly according to claim 1, wherein the spacers are substantially identical and having a length between a first and second end, said length being between 5 mm to 100 mm.

4. A window assembly according to claim 1, wherein the spacers are substantially identical and having a cylindrical shape with a diameter from 8 mm to 40 mm.

5. A window assembly according to claim 1, wherein the spacers are attached to the inner portion by welding, gluing, screws, or rivets.

6. A window assembly according to claim 1, wherein the spacers are attached to the glass list by screws, or rivets.

7. A window assembly according to claim 1, wherein the spacers are attached to the inner portion and the glass list at intervals ranging from 20 mm to 150 mm.

8. A window assembly according to claim 1, wherein the glass list is formed as a rim that is square, rectangular or circular.

9. A window assembly according to claim 1, wherein the window assembly further comprises a window glass.

10. A window assembly according to claim 1, wherein the off-shore construction is one or more of a ship, a vessel, an oil rig and a gas rig.

11. A method for manufacturing a window assembly for being mounted in an aperture or opening in an offshore construction, said method comprising
providing a window frame having an outer portion and an inner portion, where said outer portion is adapted to be attached to an outer part of said offshore construction, said inner portion being adapted for engagement with a shielding unit,
providing a window glass having a first side and a second side and being adapted for closing said aperture or opening and having a first periphery along the first side being adapted for covering and contacting at least a part of said inner portion,
providing a glass list being adapted for covering and contacting a second periphery along the second side of the window glass and pressing said first periphery of the window glass against said inner portion, said window glass and the glass list forming the shielding unit,
attaching spacers to the inner portion,
placing the window glass between the inner portion and the glass list, and
connecting said glass list to the inner portion by attaching the glass list to the spacers thereby providing a distance between the inner portion and the glass list, and thereby encapsulating the window glass between the inner portion and the glass list.

12. A method according to claim 11, wherein the spacers are attached to the inner portion by means of welding.

13. A method according to claim 11, wherein the glass list is attached to the spacers by means of weld bolt or screws.

14. A window assembly according to claim 1, wherein the window frame has an L-shaped cross section.

15. A window assembly according to claim 3, wherein the length of the spacers is between 10 mm to 50 mm.

16. A window assembly according to claim 4, wherein the diameter of the spacers is from 10 mm to 30 mm.

17. A window assembly according to claim 7, wherein the spacers are attached to the inner portion and the glass list at intervals ranging from 35 mm to 100 mm.

18. A window assembly according to claim 9, wherein the window glass is in the outer portion of the window frame.
